(19) United States
(12) Patent Application Publication
(10) Pub. No.: US 2020/0220152 A1
(43) Pub. Date: Jul. 9, 2020

(54) CONDITIONING OF LITHIUM SULFUR CELLS

(71) Applicant: The Regents of the University of California, Oakland, CA (US)

(72) Inventors: Cengiz S. Ozkan, San Diego, CA (US); Mihrimah Ozkan, San Diego, CA (US); Jeffrey Bell, Northridge, CA (US); Rachel Ye, Riverside, CA (US); Daisy Patino, Riverside, CA (US)

(21) Appl. No.: 16/525,126

(22) Filed: Jul. 29, 2019

Related U.S. Application Data
(60) Provisional application No. 62/682,790, filed on Jun. 8, 2018.

(51) Int. Cl. H01M 4/04; H01M 10/052

(52) U.S. Cl. CPC H01M 4/0447; H01M 2220/20; H01M 10/052

(57) ABSTRACT

A method of conditioning a lithium-sulfur battery is disclosed. A battery that is conditioned by the methods shown is also disclosed. Disclosed methods avoid excess polysulfide shuttling in the voltage plateau associated with the formation of long chain polysulfides, while targeting the lower voltage plateau, at a slower rate, associated with solid formation on the carbon matrix.

### RELATED APPLICATION

This application claims priority to U.S. Provisional Patent Application No. 62/682,790, entitled “METHODOLOGY FOR CONDITIONING LITHIUM SULFUR CELLS,” filed on Jun. 8, 2018, which is incorporated herein by reference in its entirety.

### TECHNICAL FIELD

Embodiments described herein generally relate to conditioning of batteries. Specific examples include conditioning of lithium-sulfur batteries.

### BACKGROUND

With demand for fossil fuels declining and the demand for clean energy rising, the automotive industry is turning towards the development of electric vehicles (EVs) for the future of transportation. In order to facilitate EVs' implementation into industry, researchers need to further explore battery technologies with higher capacities that can translate to longer driving ranges. The primary materials under consideration for next generation lithium-ion batteries are sulfur (S) and silicon (Si). Sulfur is a cathode-based material with a capacity of 1675 mAh/g and cost of $0.50/g, while silicon is an anode-based material with a capacity of 4200 mAh/g and a cost of $0.50/g. Although silicon is a material of great interest, current full cell lithium-ion batteries are cathode limited at 170 mAh/g. This has caused a push amongst the research community to focus on alleviating several of the issues a sulfur cathode faces.

Improved performance of lithium sulfur batteries is desired.

### BRIEF DESCRIPTION OF THE DRAWINGS

FIG. 1(A-C) shows city driving data in accordance with some example embodiments.

FIG. 2(A-C) shows highway driving data in accordance with some example embodiments.

FIG. 3(A-B) shows Cyclic Voltammetry data of batteries in accordance with some example embodiments.

FIG. 4(A-B) shows Galvanostatic Cycling data of batteries in accordance with some example embodiments.

FIG. 5(A-B) shows Coulombic efficiency data of batteries in accordance with some example embodiments.

FIG. 6(A-D) shows Galvanostatic Intermittent Titration Technique (GITT) a data of batteries for city driving in accordance with some example embodiments.

FIG. 7(A-D) shows Galvanostatic Intermittent Titration Technique (GITT) data of batteries for highway driving in accordance with some example embodiments.

FIG. 8(A-D) shows CV data for Methods 1, 2, & 3 batteries after (a) week 1, (b) week 2, (c) week 3 and (d) week 4 of city model driving in accordance with some example embodiments.

FIG. 9(A-D) shows CV data for Methods 1, 2, & 3 batteries after (a) week 1, (b) week 2, (c) week 3 and (d) week 4 of highway model driving in accordance with some example embodiments.

FIG. 10 shows aging cycle capacity and voltage profile during highway driving of control battery in accordance with some example embodiments.

FIG. 11(A-D) shows impedance parameters of batteries tested by the city model after each GITT, aging cycle, and CV test (a) ESR. (b) Rsei. (c) Rct. (d) Qw2 in accordance with some example embodiments.

FIG. 12(A-D) shows impedance parameters of batteries tested by the highway model after each GITT, aging cycle, and CV test (a) ESR. (b) Rsei. (c) Rct. (d) Qw2 in accordance with some example embodiments.

FIG. 13 shows thermogravimetric analysis of acetylene black sulfur composite in accordance with some example embodiments.

FIG. 14 shows current rate used to simulate corresponding driving speed in accordance with some example embodiments.

FIG. 15 shows an example method of conditioning a battery in accordance with some example embodiments.

FIG. 16 shows an example of a battery according to an embodiment of the invention.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Sulfur as a battery material faces several challenges with its electrochemistry. These problems include volumetric expansion/contraction, poor electrical conductivity, and polysulfide shuttling. Volumetric expansion/contraction results from a density change in sulfur during lithiation-delithiation causing mechanical pummeling of the electrode. Mechanical pummeling causes electrode degradation leading to cell instability and capacity fading. Sulfur is electrically insulating, requiring electrodes to have sufficient carbon additives to achieve practical current rates at the cost of reducing the sulfur content in the electrode. Polysulfide shuttling results from long chain polysulfides (L₂S₈ to Li₂S₄) in the higher voltage plateau being soluble in the ether electrolyte. The soluble long chain polysulfides shuttle from the sulfur electrode across the separator, and form on the counter electrode. This results in the formation of an insulating layer on the counter electrode, reducing conductivity while also causing capacity loss due to shuttled sulfur. Problems in the electrochemistry are not the only issues lithium-sulfur batteries face.

Sulfur also faces issues concerning processing and electrode conditioning. Sulfur has a low melting temperature at 160° C. and its morphologies can be altered at even lower temperatures around 100° C. This requires processing to utilize methods that avoid high heat or methods that generate excess heat, such as ball milling. Furthermore, due to the relatively new nature of lithium-sulfur batteries, little has been done to understand the optimal method of conditioning a lithium-sulfur battery. Current practice amongst researchers is to slowly discharge/charge lithium-sulfur batteries for a few cycles before utilizing higher current rates.

Herein, we investigate three different methods to conditioning a lithium-sulfur cell tested under EV driving conditions. The performance and health of the three different cells were investigated using GITT, CV, GCPL, and EIS. All batteries conditioned by the three different methods were cycled under simulated highway and driving conditions to represent real life applications. Currents were calculated using normal driving habits as a basis. Of the three different methods, method 3 shows an increase in capacity of 20% comparatively, higher stability, and better long-term electrode health.

### Experimental Details:

### Material Synthesis

The battery used for the EV testing consists of a sulfur electrode countered by a lithium metal anode. The sulfur electrode was made with 20 wt. % Poly(acrylic acid) (PAA, 1800 g mol. Sigma-Aldrich) and 80 wt. % acetylene black sulfur composite (ABS). The aforementioned ABS was made by dissolving 200 mg of Sulfur (S, 99.998% trace metals basis, Sigma-Aldrich) in 20 ml of Dimethyl Sulfoxide (DMSO, Fisher Chemical) at 90° C. heated by a heating jacket (Brisk Heat). 129 mg of Acetylene black (Alfa Aesar, 50% compressed) was then added to the solution. The solution was stirred for 3 hours before the heating jacket was removed and the solution was allowed to cool while stirring. The resulting ABS composite was then washed by anhydrous ethanol (Decon Labs, Inc.) several times to ensure the removal of DMSO and dried at 60° C. for 24 hours. To make the sulfur electrode, 20 wt. % Poly(acrylic acid) (Sigma Aldrich, 450,000) and 80 wt. % ABS was mixed with 1-Methyl-2-pyrrolidinone (NMP, Sigma-Aldrich) and then casted on a large piece of aluminum foil (Alfa Aesar, 0.025 mm thickness, 99.45% purity) by a doctor blade (MTI Automatic Thick Film Coater, BYK Doctor Blade). The casted electrode sheet was then dried in a convection oven (Cole-Parmer, Stable Temp) at 60 C for 24 hours. The electrodes were calendered with a 0.04 mm gap using a calendering machine (IRM) before being constructed into a coin cell

### Electrochemical Characterization

To make the sulfur half cell, a lithium foil electrode 116 mm in diameter) was first put inside a negative cap (MTI type 2032 coin cell case) Next, separators (Celgard 25 um 3501) of various sizes were placed on top to prevent any possibility of shorting. Sulfur electrode (16 mm in diameter) was then placed on top followed by two spacers, a spring, and the positive cap while electrolyte was added in between (1:1 DOL:DME, 1 wt. % LiN0₃, 1 M LiTFSI). The battery was then sealed using a battery crimper (MTI, MSK-1600). All cell assembly was done inside an Argon filled glovebox (H₂0<0.5 ppm, 02<0 2 ppm, Vacuum Atmosphere Co.). The battery was then tested under room temperature with a Bio Logic (BCS 810 Testing Module) using different testing methods, including Galvanostatic Cycling with Potential Limitation (GCPL), Cyclic Voltammetry (CV), Potentio Electrochemical Impedance Spectroscopy (PEIS) and Galvanostatic Intermittent Titration Technique (GITT) in voltage window ranging from 1.7V to 2.8V

### Results and Discussion

Various battery testing methods were used to evaluate cells pre/during/post simulated driving. The sulfur electrodes were made using an ABS composite with PAA as detailed in the methods section. The Li−S cells were then assembled into coin cells with lithium foil acting as the counter electrode. The sulfur loading for each battery is 2.5 mg/cm². The cells were then conditioned using three different example methods. The C rate is defined as that which would theoretically fully charge or discharge the battery in one hour. Method 1 applies a current rate of C/50 (0.175 mA) during discharge and charge for 3 cycles. Method 2 applies GITT current pulses at 10 min intervals at C/50 for 3 cycles. The rest between current pulses allows for voltage equalization, which will prolong the discharge process and maximize material reduction in the electrode. Lastly, Method 3 applies a rate of C/50 during discharge from 2.8 V to 2.1 V and a rate of C/100 (0.0875 mA) from 2.1 V to 1.7 V. This method avoids excess polysulfide shuttling in the voltage plateau associated with the formation of long chain polysulfides, while targeting the lower voltage plateau, at a slower rate, associated with solid formation on the carbon matrix. All example methods charge batteries at a rate of C/50; each conditioning procedure is repeated for three cycles. In some methods, the conditioning procedures can be done from one cycle, two cycles, three cycles, four cycles, five cycles, to six cycles, or combination thereof, such as three cycles.

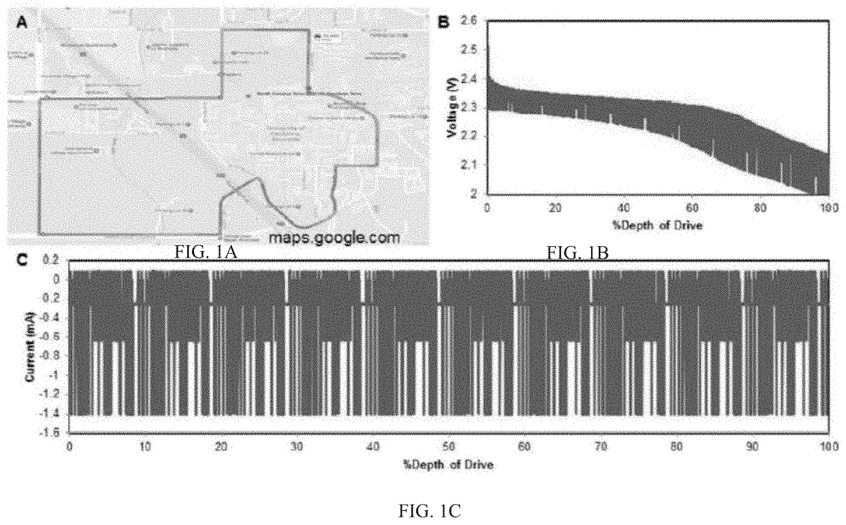

FIG. 1: A) Map of city driving route from google maps. B) Voltage versus percent depth of drive profile C) Current versus percent depth of drive profile.

The city-cycling method was designed to simulate the different discharge rates an EV battery is experiencing while the EV is driven in a city. The difference between this city-cycling method and a normal constant current method is that the former consists of a series of different discharge rates due to different energy consumption needs of an EV. To simulate real life driving conditions, corresponding discharge rates were estimated based on data released for Tesla Model Selectric vehicles. Based on the Tesla official website, the discharge rate of the 750 Model S EV is around C/5 when driving at 60 mph Considering that the theoretical specific capacity of a sulfur lithium cell is around 8 times the specific capacity of the current commercial cell, the base rate used for the city- and highway-cycling condition was C/30. Based on the constant driving condition, a light accelerate condition and a hard accelerate condition were simulated using C/10 and C/5 respectively, C/100 was also used to simulate braking energy recovery. A driving route was then designed based on Google maps, as shown in FIG. 1A, consisting of lights, stop signs, turns, and speed bumps. FIG. 1 C shows the detailed rate change of the city-cycling method, and FIG. 1 B shows the resulting voltage change of the base battery. According to FIG. 1 B, a fully charged battery will have a voltage around 2V at the end of the city cycle. This means that the battery has passed the long chain polysulfide voltage region and entered the lower kinetic region and has started to form insoluble polysulfides.

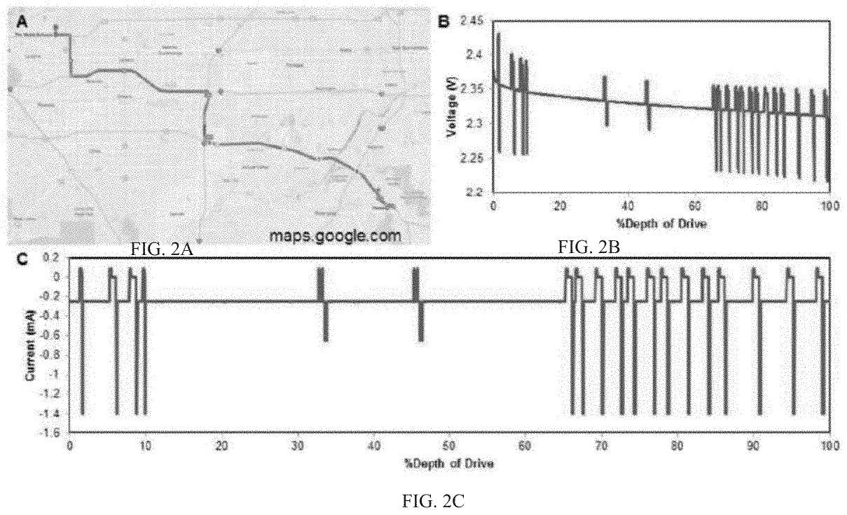

FIG. 2: A) Map of highway driving route from google maps. B) Voltage versus percent depth of drive profile. C) Current versus percent depth of drive profile.

Similar to the city-cycling method, a highway-cycling method was designed based on Google maps, as shown in FIG. 2A. Comparing to the city-cycling method the highway-cycling method has less current rate variation. Thus. FIG. 28 shows a fully charged battery will remain in the long chain poly sulfide voltage region at the end of the cycle. This indicates that the battery was put through much less stress compared to the batteries that went through the city-cycling method. This will also result in a change in their respective performance from city batteries to highway batteries.

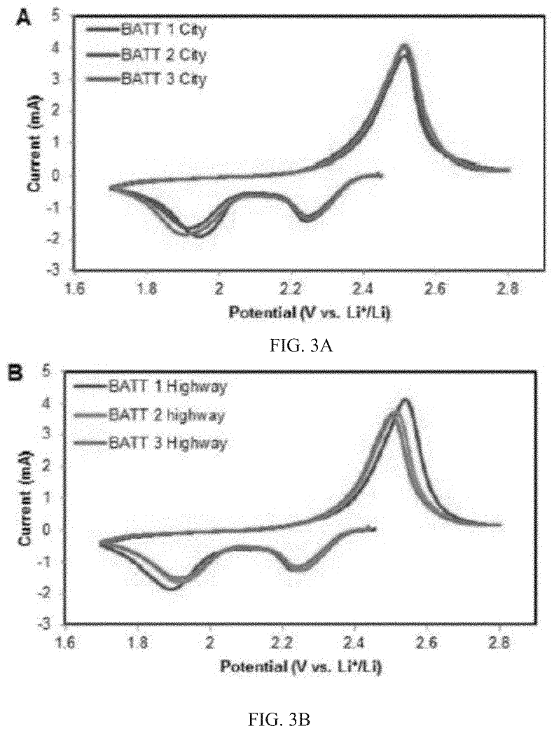

FIG. 3: A) Cyclic Voltammetry of batteries utilizing 1, 2, & 3 condition for city driving method. B) Cyclic Voltammetry of batteries for driving conditions 1, 2, & 3 for highway driving method

Cyclic voltammetry test was conducted to each of the batteries after each of the batteries were cycled. The CV tests were carried out between the voltage of 1.7V and 2.8V, as shown in FIG. 3A and FIG. 3B. The CV curves of all of the batteries match with the typical sulfur CV curve, which has two cathodic peaks at 1.9V and 2.3V, and one anodic peak at 2.5V. The cathodic peak at 2.3V corresponds to the formation of long chain poly sulfide, while the 1.9V peak is a result of the lithium sulfide formation Slight variations of peak voltages exist between the batteries due to the different conditioning method, this exists in both the city cycled batteries and the highway cycled batteries. As shown in FIG. 3A, between the city cycled batteries, battery 1 C with the C/50 condition method has a higher cathodic peak voltage at 1.9V. This is due to higher amount of poly sulfide shuttling that changes the ionic conductivity of the battery. Battery 3C has approximately the same peak voltage with battery 2C, but battery 3C has a larger peak, which indicates higher capacity and better material utilization FIG. 38 shows the CV curves of the highway cycled batteries. As shown, battery 1 H has a lower cathodic peak voltage comparing to battery 1 C due to the less cycling stress, and higher long-chain polysulfide utilizing rate which results in less polysulfide shuttling. Same trend exists in battery 2H and battery 3H comparing to battery 2C and 3C. The difference between battery 1 H and the other two highway cycled batteries is due to a worse conductive network formation during conditioning, which leads to a lower ionic and electric conductivity.

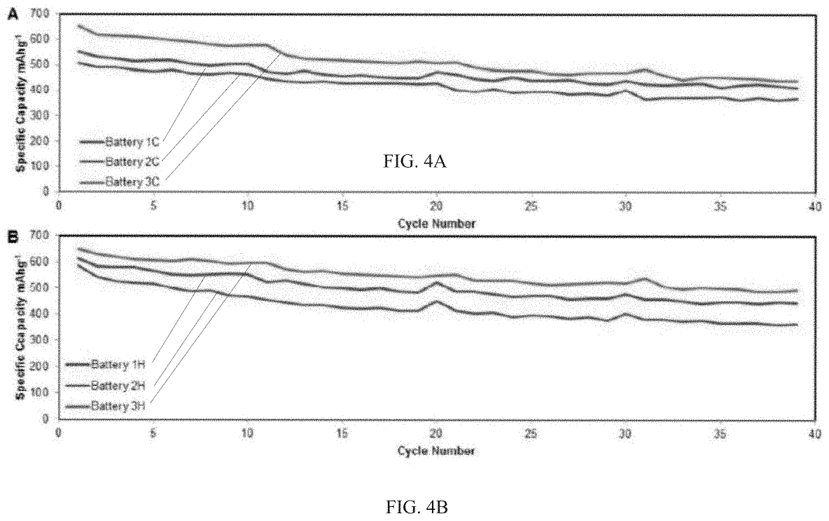

FIG. 4: A) Galvanostatic Cycling with limited potential for battery conditions 1, 2, & 3 driving in the city. B) Galvanostatic Cycling with limited potential for battery conditions 1, 2, & 3 driving on the Highway.

The batteries were discharged and charged for ten cycles after each GITT test to simulate battery aging. The corresponding specific capacity vs cycle number plot from the galvanostatic cycling test is shown in FIG. 4. The save like variation in capacity is due to the change of room temperature while the battery is being tested. Although all batteries show a fluctuation in capacity when the temperature changes, it is noticeable that battery 3C and 3H has the least fluctuation. This is due to conditioning method 3 creating a stable solid electrolyte interphase (SEI) layer during the conditioning cycles. In both city-cycled batteries and highway-cycled batteries, condition 3 batteries have the highest capacity, while condition 2 batteries have the lowest capacity. Since the batteries all have similar amount of sulfur, having a higher capacity indicates that the cell losses less active sulfur during the previous testing routine. This active sulfur loss can be a result of SEI layer formation, polysulfide shuttling into the electrolyte, polysulfide shuttling to the anode side, and sulfur detaching from the conductive network during volume expansion and contraction. Condition method 3 yields a higher capacity because it creates a better SEI layer than condition 1 during the condition cycles, which decreases further polysulfide shuttling.

Having a robust SEI layer during the condition cycles also prevents the SEI layer from cracking and exposing more material to the electrolyte, which generates new and excess amount of SEI layer. Condition method 2 yields the lowest capacity because it spent more time in the long chain polysulfide region which allows more time for polysulfide shuttling to occur. Condition method 2 also activates sulfur that is not closely attached to the conductive network due to its slow rate, creating more volume expansion and more polysulfide shuttling. Furthermore, due to the city-cycling method being more stressful than the highway-cycling method. FIG. 4A shows the city cycled battery capacities converging toward an equilibrium point while FIG. 48 shows the highway cycled battery capacities decrease with similar speed. The convergence is noticeable within the 40 aging cycles because of the high cycling stress, this causes the battery to lose sulfur to polysulfide shuttling rapidly. Since polysulfide shuttling can be suppressed once the polysulfide concentration in the electrolyte reaches a saturation point, only a limited amount of capacity can be lost at a rapid rate due to polysulfide shuttling. This means that all of the batteries twill reach a similar resulting capacity due to the consistent sulfur weight in the batteries, thus creating a converging capacity plot.

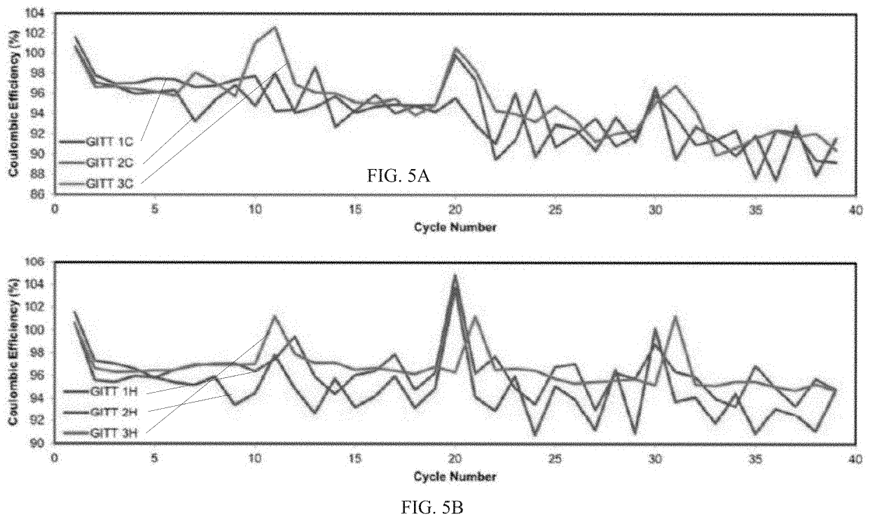

FIG. 5: A) Coulombic efficiency profiles for battery conditions 1, 2, & 3 driving in the city. B) Coulombic efficiency profiles for battery conditions 1, 2, & 3 driving on the Highway.

FIGS. 5A and 5B shows the aging cycle coulombic efficiencies of all batteries. Large spikes of coulombic efficiency exist at the start of each aging cycle (1st, 11st, 21st, and the 31st cycle) due to the GITT test before the aging cycles. This is due to the GITT test disrupting the coulombic efficiency of the cycle following it by over-charging the battery and activating sulfur that does not participate during normal cycling due to the limitation of the conductive network. As a result, the following cycle has an increased discharge capacity and causes the coulombic efficiency to be over 100% when the charge capacity of that cycle stays normal. In both FIGS. 5A and 5B, battery that was conditioned by method 3 has the highest and most stable coulombic efficiency. The Coulombic efficiency of battery 3C and 3H being high indicates that condition method 3 yields the best conductive network, which enables the battery to utilize the most amount of the charged sulfur during discharge Condition method 3 also yields the most stable coulombic efficiency comparing to other condition methods. This can be seen from the least temperature fluctuation and the least coulombic efficiency fading of battery 3C and 3H in Figure SA and SB, indicating that condition method 3 creates a stable SEI layer. This is also in agreement with FIGS. 4A and 4B, where the capacity fluctuation is small comparing to the other batteries due to a good SEI layer.

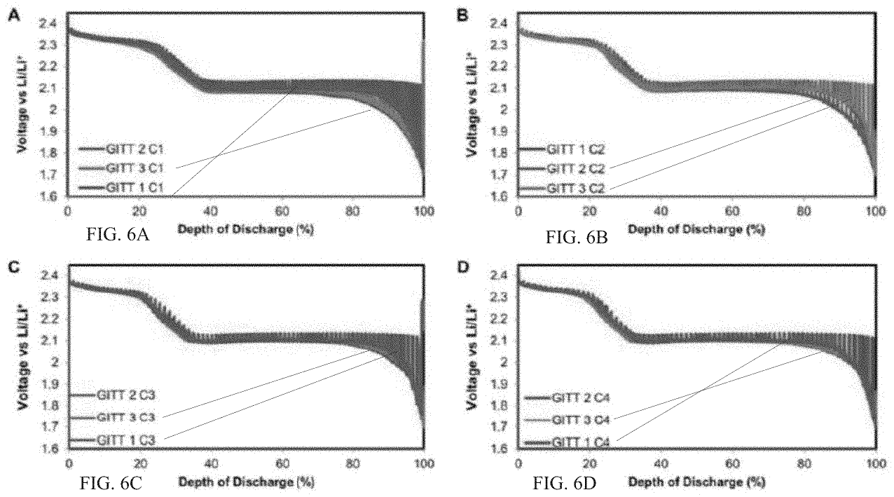

FIG. 6: A) GITT for conditioning methods 1, 2, & 3 after week 1 of simulated city driving. B) GITT for conditioning methods 1, 2, & 3 after week 2 of simulated city driving. C) GITT for conditioning methods 1, 2, & 3 after week 3 of simulated city driving D) GITT for conditioning methods 1, 2, & 3 after week 4 of simulated city driving.

GITT is an electroanalytical procedure used to analyze the diffusivity of lithium within an electrode. The procedure consists of a series of current pulses, each followed by a relaxation period. Herein, the ABS half cells were subjected to current pulses at C/50 for 10-minute intervals, followed by 1 O minute rest periods until complete discharge/charge. This GITT procedure was repeated for each conditioning method at intervals of one week of simulated driving, as depicted in FIG. 6. The delta in the voltage profile (or the thickness of the voltage curve) is indicative of the ease of lithium diffusivity in the system, whereas a thinner curve represents higher kinetics in lithium diffusivity and/or more material activation.

FIG. 6A shows conditioning method 1 after the first week of driving yields significantly better lithium diffusivity than conditions/methods 2 and 3. Method 2 has the broadest voltage curve, indicating slower material activation that can be attributed to a thicker layer of SEI formation in addition to more active material participating in the first conditioning cycle. In FIG. 6B, each voltage curve appears to have decreased in width, indicating all conditions noticeably improved in lithium diffusivity after two weeks of city driving. We can infer that the subsequent week of driving helped activate more residual sulfur sites FIG. 6C shows the voltage curves for method 1 continues to decrease in width after the third week of driving, indicating an undesired continuous change in diffusion. Changes in diffusion for lithium sulfur batteries tend to relate to loss of active material or changes in the SEI formation on the electrode. Ideally, for lithium-sulfur batteries voltage trends in a GITT profile should remain consistent, indicating of steady kinetics i.e. material activation, SEI formation. FIG. 4 shows the voltage trends for conditioning methods 1 and 2 continue to thin; the electrodes continue to experience an increase in lithium diffusivity. The continuing change in diffusion is attributed to an excess loss of sulfur due to polysulfide shuttling.

Analyzing each week post city driving, method 3 seems to have the steadiest lithium diffusivity throughout. This is attributed to the steady formation of an SEI layer and does not lose active sulfur sites throughout the stresses induced from the driving route.

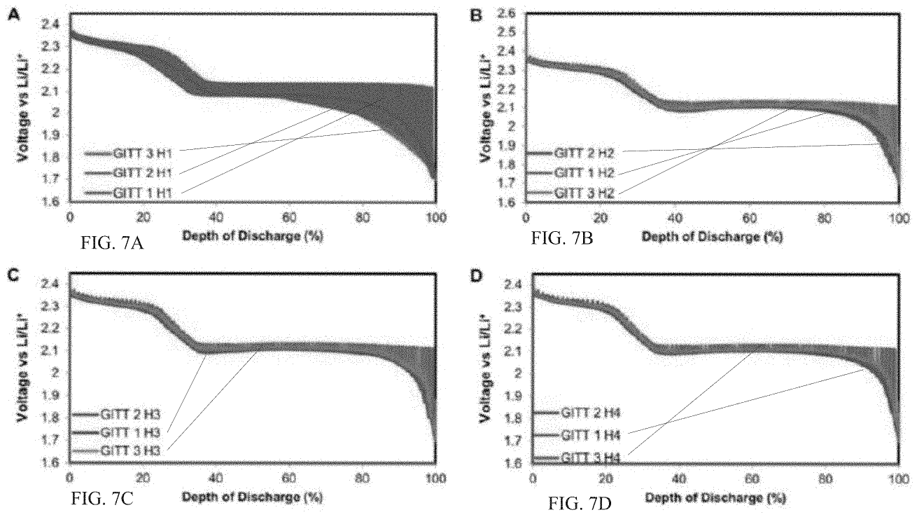

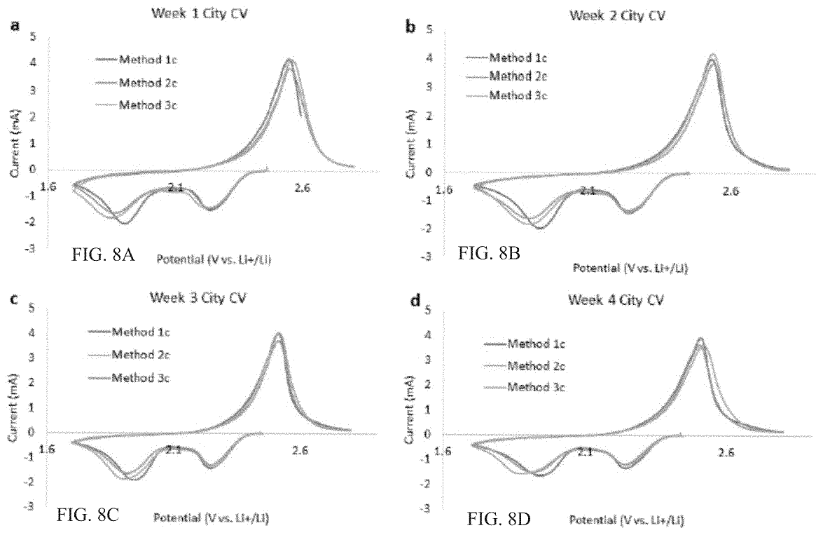

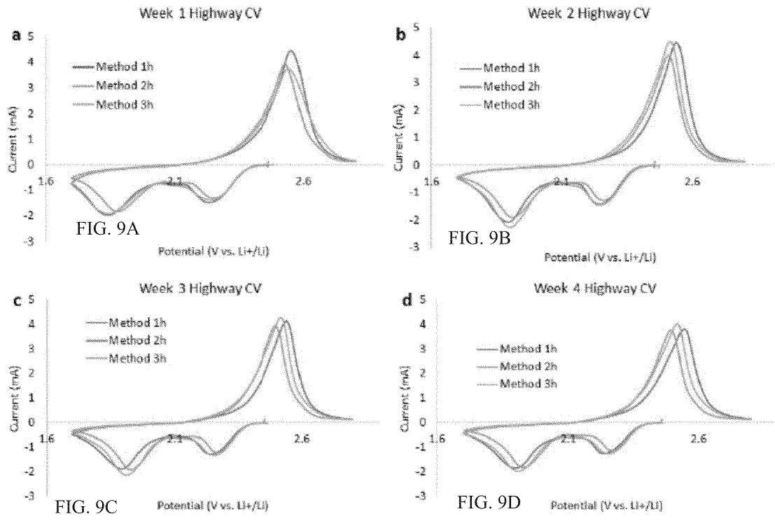

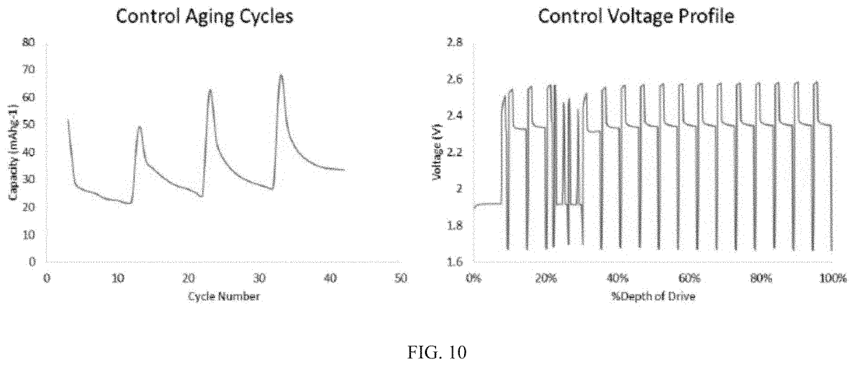

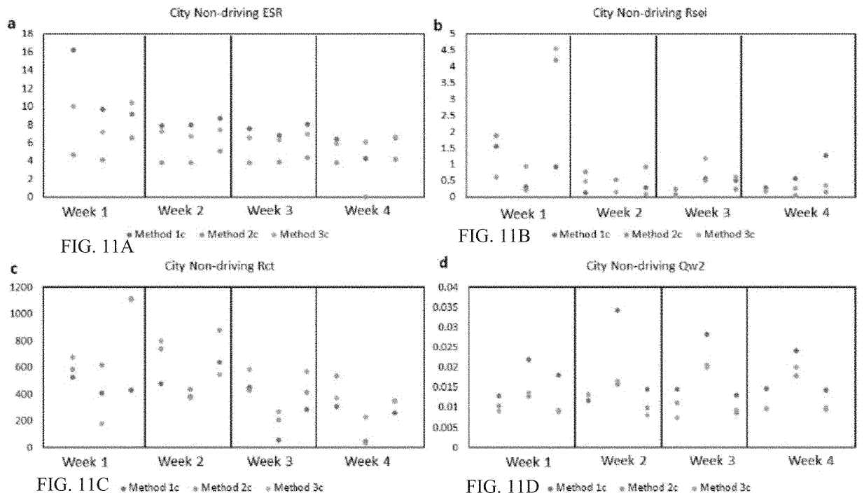

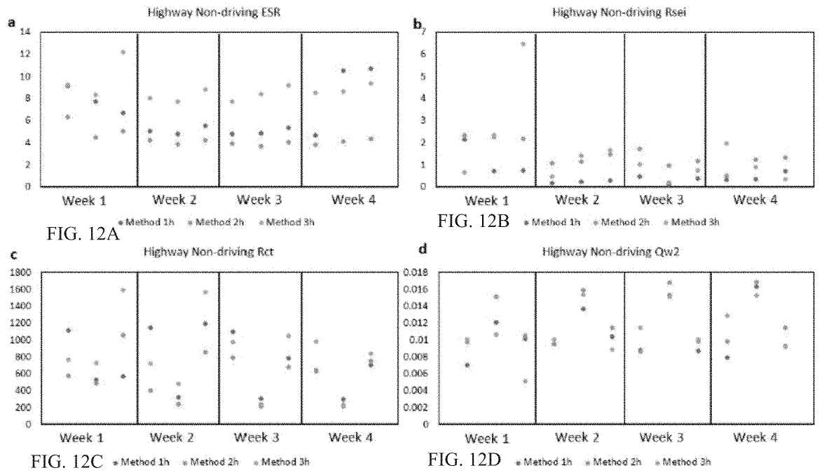

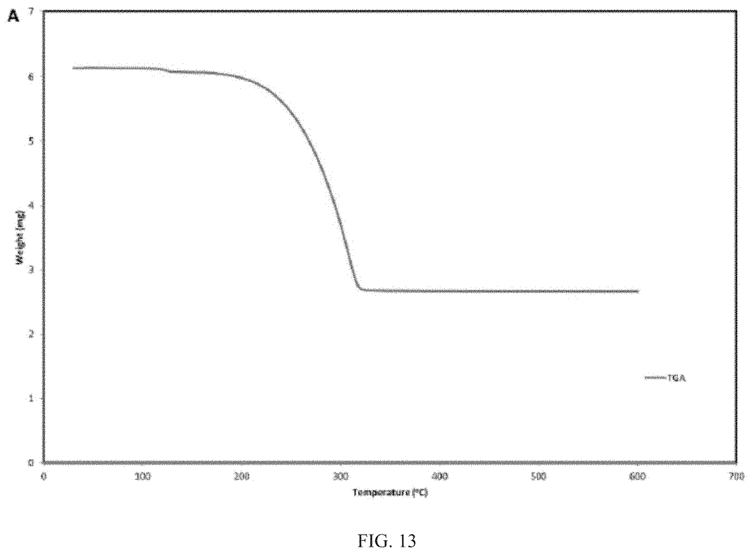

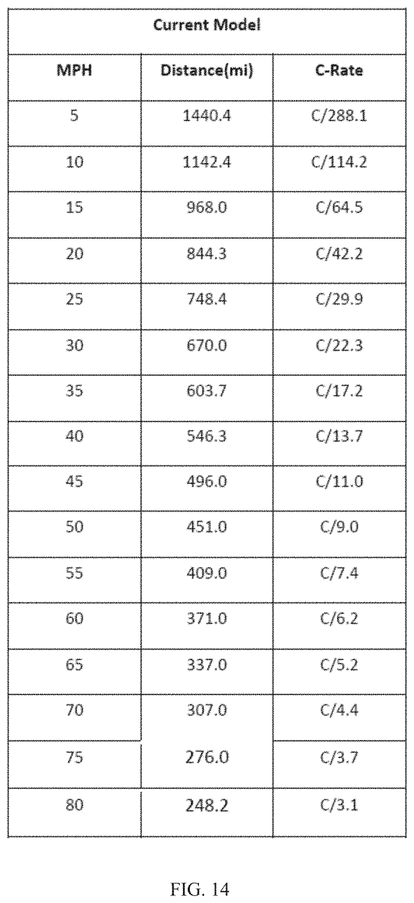

FIG. 7: A) GITT for conditioning methods 1, 2, & 3 after week 1 of simulated highway driving B) GITT for conditioning methods 1, 2, & 3 after week 2 of simulated highway driving. C) GITT for conditioning methods 1, 2, & 3 after week 3 of simulated highway driving D) GITT for conditioning methods 1, 2, & 3 after week 4 of simulated highway driving.

The GITT analysis after the first week of highway driving differs starkly to city driving. The decreased diffusions after week 1 compared to city is attributed to the reduced stress placed on the electrode, resulting in less damage to the structure. Similar to the GITT results for city driving, conditioning methods 2 & 3 exhibit poor lithium diffusivity compared to method 1. In the subsequent driving cycles, method 3 retains a stable diffusivity after the second week, while methods 1 & 2 continually increase in diffusivity in the subsequent cycles. The stable diffusivity observed in method 3 for highway driving alludes to minor changes occurring in the electrode which can be attributed to the higher capacity seen by conditioning method 3, as seen in FIG. 4B.

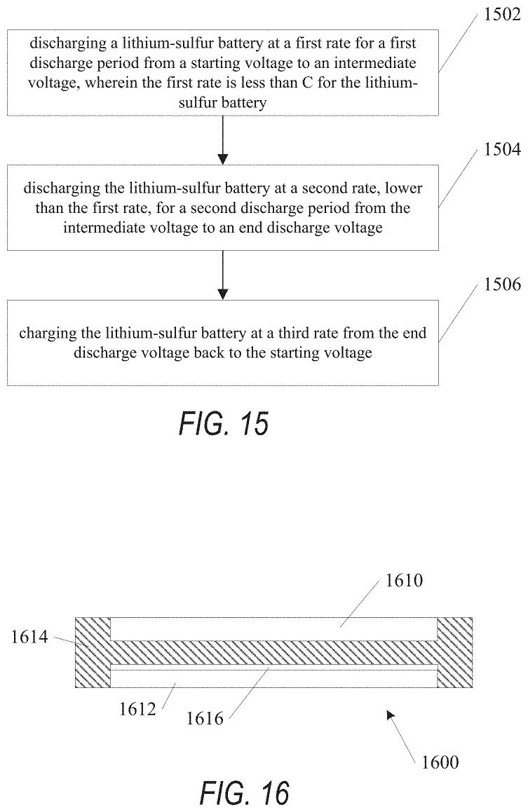

FIG. 15 show an example method according to an embodiment of the invention. In operation 1502 a lithium-sulfur battery is discharged at a first rate for a first discharge period from a starting voltage to an intermediate voltage, wherein the first rate is less than C for the lithium-sulfur battery. IN operation 1504, the lithium-sulfur battery is discharged at a second rate, lower than the first rate, for a second discharge period from the intermediate voltage to an end discharge voltage. In operation 1506, the lithium-sulfur battery is charged at a third rate from the end discharge voltage back to the starting voltage. In one example, the operations (1502-1504) are performed for a number of cycles. In one example, the number of cycles is three.

FIG. 16 shows an example of a battery 1600 according to an embodiment of the invention. The battery 1600 is shown including an anode 1610 and a cathode 1612. An electrolyte 1614 is shown between the anode 1610 and the cathode 1612. In one example, the battery 1600 is a lithium-sulfur battery as described in the disclosure above. In one example the battery 1600 includes a solid electrolyte interphase (SEI) 1616 formed as a result of a conditioning method as described. In one example, the conditioning method includes the method described in the flow chart of FIG. 15.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A method of conditioning a battery, comprising:
performing a plurality of conditioning cycles, wherein each cycle includes:
discharging a lithium-sulfur battery at a first rate for a first discharge period from a starting voltage to an intermediate voltage, wherein the first rate is less than C for the lithium-sulfur battery;
discharging the lithium-sulfur battery at a second rate, lower than the first rate, for a second discharge period from the intermediate voltage to an end discharge voltage; and
charging the lithium-sulfur battery at a third rate from the end discharge voltage back to the starting voltage.

2. The method of claim 1, wherein the first rate is C/50.

3. The method of claim 1, wherein the second rate is C/100.

4. The method of claim 1, wherein the third rate is C/50.

5. The method of claim 1, wherein the starting voltage is approximately 2.8 volts.

6. The method of claim 1, wherein the intermediate voltage is approximately 2.1 volts.

7. The method of claim 1, wherein the end discharge voltage is approximately 1.7 volts.

8. The method of claim 1, wherein the plurality of conditioning cycles is from one to six conditioning cycles.

9. A conditioned lithium-sulfur battery, comprising:
an anode and a cathode, separated by an electrolyte;
a solid electrolyte interphase (SEI) formed by a method, including performing a plurality of conditioning cycles, wherein each cycle includes:
discharging a lithium-sulfur battery at a first rate for a first discharge period from a starting voltage to an intermediate voltage, wherein the first rate is less than C for the lithium-sulfur battery;
discharging the lithium-sulfur battery at a second rate, lower than the first rate, for a second discharge period from the intermediate voltage to an end discharge voltage; and
charging the lithium-sulfur battery at a third rate from the end discharge voltage back to the starting voltage.

10. The conditioned lithium-sulfur battery of claim 9, wherein the first rate is C/50.

11. The conditioned lithium-sulfur battery of claim 9, wherein the second rate is C/100.

12. The conditioned lithium-sulfur battery of claim 9, wherein the third rate is C/50.

13. The conditioned lithium-sulfur battery of claim 9, wherein the starting voltage is approximately 2.8 volts.

14. The conditioned lithium-sulfur battery of claim 9, wherein the intermediate voltage is approximately 2.1 volts.

15. The conditioned lithium-sulfur battery of claim 9, wherein the end discharge voltage is approximately 1.7 volts.

16. The conditioned lithium-sulfur battery of claim 9, wherein the plurality of conditioning cycles is from one to six conditioning cycles.
